(19) United States
(12) Patent Application Publication
(10) Pub. No.: US 2006/0014553 A1
(43) Pub. Date: Jan. 19, 2006

(54) Wireless communication terminal for unifying multiple messages and method thereof

(76) Inventors: Jeong-Won Oh, Seoul (KR); Heuk-Jae Choi, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/182,626

(22) Filed: Jul. 14, 2005

(30) Foreign Application Priority Data
Jul. 16, 2004 (KR) 10-2004-0055668

(51) Int. Cl. H04Q 7/20

(52) U.S. Cl. 455/466; 455/412.1

(57) ABSTRACT

A wireless communication terminal having a function for unifying multiple messages and a method thereof are disclosed. The wireless communication terminal having a function for unifying multiple messages includes: a wireless transceiver; an output unit; a memory for storing a multi-message unifying interface program, a multi-message unifying program, transmitting messages, receiving messages, and a unified message; an input unit for receiving a selection signal for selecting one or more transmitting/receiving messages or a multi-message unifying menu key through a multi-message unifying interface; and a controller for driving the multi-message unifying interface program and the multi-message unifying program, and generating single unified message by unifying the selected transmitting/receiving messages selected according to the selection signal.

### FIELD OF THE INVENTION

The present invention relates to a wireless communication terminal for unifying multiple messages and a method thereof; and, more particularly, to a wireless communication terminal for unifying a plurality of small-size messages into single large-size message, transmitting the unified message to a back-up server or other wireless communication terminal, and updating the small-size messages to the unified single message in order to effectively and conveniently manage messages stored in the wireless communication terminal.

### DESCRIPTION OF RELATED ARTS

A wireless communication terminal denotes a handheld terminal capable of wireless communication, such as a mobile communication terminal, a personal communication service (PCS) phone, a personal digital assistant (PDA), a smart phone, a wireless local area network (LAN) terminal, and a next generation mobile communication terminal (IMT-2000).

A recently introduced wireless communication terminal has various functions for voice communication, message service, mobile banking, and digital camera. By using the message service function of the wireless communication terminal, a user of the wireless communication terminal can transmit/receive not only a small-size text message but also a large-size multimedia contents message from/to other terminals. The message service includes a short message service (SMS) and a multimedia message service (MMS). The SMS is a globally accepted wireless service that enables the transmission of text based messages between mobile subscriber and an external system such as electric mail, paging, and voice-mail systems. A size of the short message is about several 10s bytes. The MMS is also a globally accepted wireless service that enables the transmission of multimedia contents message between a mobile subscriber and an external system such as graphics, video clips, sound files and text messages. A size of the multimedia message is about several 100s Kbytes.

As a wireless communication network develops, a wireless communication terminal communicates with not only other wireless communication terminals, but also external systems such as a web service or an e-mail server in a wireless communication network. A wireless communication terminal often communicates with the external systems for receiving/transmitting multimedia messages while the short messages are generally exchanged between the wireless communication terminals.

Meanwhile, a personal competitive power in the modern society may depend on ability of collecting and accumulating information. That is, many people want to collect information for one's job, social life and personal relationship, and to store the collected information as a personal record.

Accordingly, many people use the message service function of the wireless communication terminal as a tool to exchange important information with other persons, and to store the exchanged information.

However, it is very annoying process to store and manage a plurality of messages exchanged with other persons in one's terminal. For example, a user of the wireless communication terminal must create additional folders according to a type of the messages, and must move or delete each of received or transmitted messages to corresponding folder for storing and managing the received or transmitted messages.

Furthermore, a wireless communication terminal has a limited storage space. Therefore, it is very difficult to store many messages in the wireless communication terminal for very long time. If there is insufficient space left for storing newly incoming messages, stored messages must be deleted. Or, a wireless communication may be unable to receive new messages because of insufficient storage space. Because of such a limitation, a user may feel inconvenience to use the wireless communication terminal. Therefore, there is a great a demands for a technology of storing a plurality of messages in external systems capable of communicating with a wireless communication terminal based on the message service through a wireless network.

Moreover, small size messages stored in conventional wireless communication terminals must be managed individually by a user. Therefore, it is also very annoying process for the user because same operations are often repeatedly performed for managing the small size message stored in the conventional wireless communication terminal. Accordingly, there is also a great demand for a method of effectively managing messages by unifying a plurality of small size messages into single large size message in order to reduce total number of stored messages in the wireless communication terminal.

That is, if a plurality of small size messages is unified to single large size message, the total number of stored messages is reduced, and thus the stored message may be managed effectively. Also, the stored message in the wireless communication terminal can be conveniently transferred to the external system. Therefore, it expects that the plurality of small size messages can be effectively and conveniently managed and transmitted to the external system if a plurality of small size message is unified into the single large size message.

For example, if a plurality of short text messages is unified into single multimedia message, the total number of stored messages is reduced, and thus the stored message may be effectively managed. Also, the short text messages stored in the wireless communication terminal may be conveniently transferred to the other terminals by transmitting the unified multimedia message as a plurality of short messages. Furthermore, since the multimedia message can be transmitted/received to various types of external devices in a wireless communication network such as an e-mail server, the plurality of short text messages can back-up to the external devices by unifying the plurality of the short text messages into the single multimedia message and transmitting the unified multimedia message to the back-up server as the short text messages.

Additionally, it is expected that more messages can be stored in limited storage space of the wireless communication terminal if a plurality of small size messages is unified into single large size message. Stored messages in the conventional wireless communication terminal are automatically deleted by checking a total number of stored messages, not calculating a total size of stored message. That is, stored messages may be automatically deleted when the total number of stored messages reaches a preset allowable number of stored messages. If a plurality of short messages is unified into single message, the total number of stored messages is reduced. Therefore, it is expected that more messages can be stored in the wireless communication terminal by unifying the short messages into single message.

### SUMMARY OF THE INVENTION

It is, therefore, an object of the present invention to provide a wireless communication terminal for unifying a plurality of small size messages to single large size message in order to conveniently manage messages and a method thereof.

It is another object of the present invention to provide a wireless communication terminal for unifying a plurality of small size message to single large size message and transmitting the unified message to the external system as the plurality of small size message in order to conveniently transmit messages and back-up the messages to external systems, such as other wireless communication terminal or an e-mail server and a method thereof.

It is still another object of the present invention to provide a wireless communication terminal for unifying a plurality of small size messages to single large size message and updating the small size messages to the unified single large size message in order to effectively and conveniently manage multiples messages in the wireless communication terminal and a method thereof.

In accordance with an aspect of the present invention, there is provided a wireless communication terminal having a function for unifying multiple messages, including: a wireless transceiver; an output unit; a memory for storing a multi-message unifying interface program, a multi-message unifying program, transmitting messages, receiving messages, and a unified message; an input unit for receiving a selection signal for selecting one or more transmitting/receiving messages or a multi-message unifying menu key through a multi-message unifying interface; and a controller for driving the multi-message unifying interface program and the multi-message unifying program, and generating single unified message by unifying the selected transmitting/receiving messages selected according to the selection signal.

The memory may store receiving-side information including a telephone number and an e-mail address, the input unit may receive the receiving-side information, and the controller may transmit the generated unified message according to the received receiving-side information.

The controller may update the selected transmitting/receiving messages stored in the memory to the generated unified message.

In accordance with an aspect of the present invention, there is also provided a method of unifying multiple messages in a wireless communication terminal including: receiving a selection signal for selecting a plurality of transmitting/receiving messages through a multi-message unifying interface, and selecting a plurality of the transmitting/receiving messages according to the selection signal; and receiving a multi-message unifying menu key through the multi-message unifying interface, and generating single unified message by unifying the selected transmitting/receiving messages according to the multi-message unifying menu key.

The method may further include: transmitting the single unified message according to receiving-side information inputted through the multi-message unifying interface.

The method may further include updating the selected transmitting/receiving messages to the single unified message.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating a wireless communication terminal for unifying multiple messages in accordance with a preferred embodiment of the present invention; and

FIG. 2 is a method of unifying multiple messages in a wireless communication terminal in accordance with a preferred embodiment of the present invention.

### DETAILED DESCRIPTION OF THE INVENTION

Hereinafter, a wireless communication terminal for unifying multiple messages and a method thereof in accordance with a preferred embodiment of the present invention will be described in more detail with reference to the accompanying drawings.

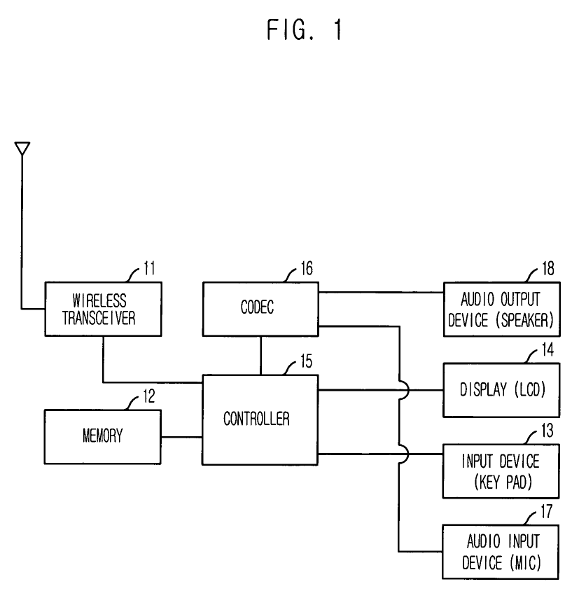

FIG. 1 is a block diagram illustrating a wireless communication terminal for unifying multiple messages in accordance with a preferred embodiment of the present invention.

As shown in FIG. 1, the wireless communication terminal for unifying multiple messages includes: a wireless transceiver 11 for transmitting/receiving various types of messages such as a short text message and a multimedia message; a memory 12 for storing a program for driving the wireless communication terminal, a multi-message unifying interface program, a multi-message unifying program (message unifying parser), various messages such as a short message and a multimedia message; an input device 13 such as a key pad for receiving input signals for selecting a short message or a multi-message unifying menu key through a multi-message unifying interface; a display 14 such as a liquid crystal display (LCD) for displaying various messages such as a short message and a multimedia message through the multi-message unifying interface; a controller 15 for driving the wireless communication terminal, the multi-message unifying interface program and the multi-message unifying program, generating single multimedia message by unifying a plurality of short messages according to the input signals for selecting one or more of short messages or the multi-message unifying menu key received through the input device 13, and controlling the functional elements of the wireless communication terminal to output the generated single multimedia message; a CODEC 16 for converting signals inputted from the transceiver 11 to voice and outputting the converted voice to an audio output device 18, and converting voice inputted from an audio input unit 17 to a signal and outputting the converted signal to the transceiver 11 in response to the controller 15; an audio input unit 17 such as a microphone for receiving the voice and transferring the voice to the CODEC 16; and an audio output device 18 such as a speaker for outputting the voice inputted from the CODEC 16.

The controller 15 of the wireless communication terminal according to the present invention also performs operations to transmit the generated multimedia message to a back-up server or other wireless communication terminal through a wireless communication network. That is, the controller 15 further performs operations to receive a signal inputted through the input device 13 for selecting one of telephones or e-mail addresses stored in the memory 12, and to transmit the generated multimedia message to the back-up server or other wireless communication terminal according to the selected telephone number of e-mail address.

Furthermore, the controller 15 performs operations to update a plurality of short messages to the generated multimedia message after unifying a plurality of short message into the multimedia message. That is, the controller 15 not only transmits the generated multimedia message to the back-up server, but also updates the short messages to the generated multimedia message. The short messages may be updated with the generated multimedia message without transmitting the generated multimedia message to the back-up server.

That is, the controller 15 generally controls operations of the wireless communication terminal, driving the multi-message unifying interface program and the multi-message unifying program. Also, the controller 15 performs the multi-message unifying function for generating the single multimedia message by unifying a plurality of short text messages into the single multimedia message. After generating the single multimedia message, the controller 15 may perform a function for transmitting the generated multimedia message to the back-up server and a function for updating the short messages with the generated multimedia message at the same time or separately.

The memory 12 stores driving programs and system programs of the controller 15. The driving programs or the system programs are generally stored in a read only memory (ROM) area, and may be deleted, occasionally. The memory 12 includes a random access memory (RAM) for temporary storing data created while performing the programs.

Especially, the memory 12 stores: the multi-message unifying interface program for providing an interface required to perform the multi-message unifying function according to the present invention; the multi-message unifying program (message unifying parser) for performing the multi-message unifying function; and various messages including transmitting/receiving messages and unified messages such as short messages and multimedia message. Also, the memory 12 stores telephone numbers and e-mail addresses.

The input device 13 is configured with a plurality of numeral keys, menu keys and functional keys for performing various functions. The input device 13 receives input signals from the user, and outputs key data generated according to the input signals to the controller 15. The input device 13 receives a short message selection signal from the user through the multi-message unifying interface. The input device 13 also includes a multi-message unifying menu key used for performing the multi-message unifying message. Furthermore, the input device 13 receives receiving-side information such as telephone numbers, e-mail addresses, and selection signals for selecting one of telephone numbers or e-mail addresses stored in the memory 12.

The display 14 is a displaying device such as a liquid crystal display (LCD). In response to the controller 15, the display 14 displays a state of the wireless communication terminal or a progression state of corresponding programs. That is, the display 14 displays general state of the wireless communication terminal or the inputted contents. Especially, display 14 displays various types of transmitting/receiving messages and unified messages such as the short messages and the multimedia messages to a user, and also displays telephone number or e-mail addresses to the user.

The transceiver 11 transmits or receives various messages such as the short messages and the multimedia messages to various external systems, such as other wireless communication terminal, an e-mail server, and a web-ser, through a wireless communication network in response to the controller 15.

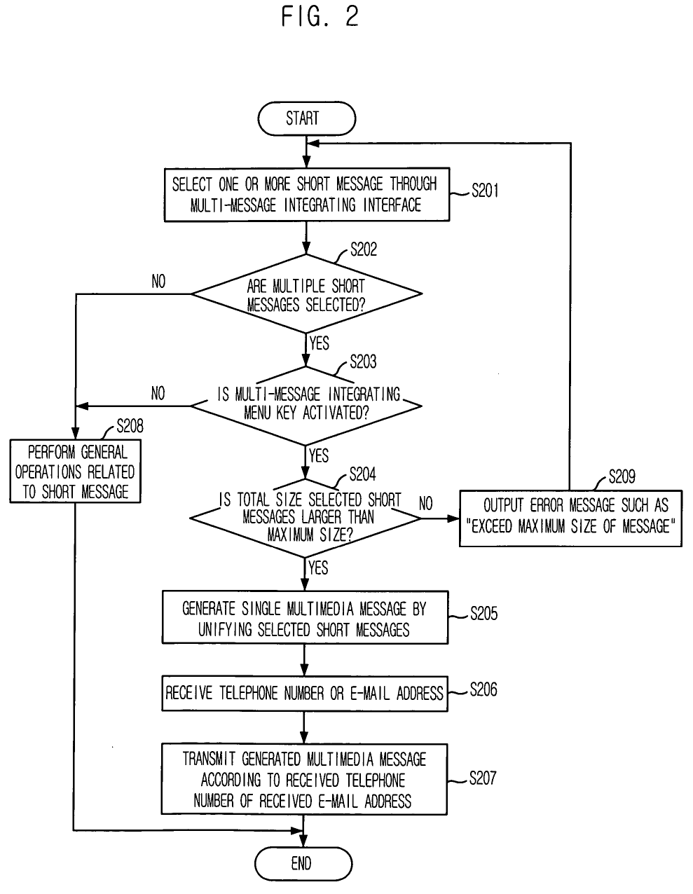

FIG. 2 is a flowchart showing a method of unifying multiple messages in a wireless communication terminal in accordance with a preferred embodiment of the present invention.

Referring to FIG. 2, a user selects one or more short messages through the multi-message unifying interface at step S201. Herein, the multi-message unifying interface may be embodied as a message management menu related to a short message provided from a typical wireless communication terminal, low-level menus of the message management menu, or additional menus. The user can select one or more of messages by using the multi-message unifying interface.

After selecting, the controller 15 determines how many short messages are selected by the user at step S202. That is, the controller 15 determines whether the selected short message is multiple or single.

If the single message is selected at the step S202, typical operations of handling a short message are performed at step S208 such as transmitting the short message or deleting the short message.

If a plurality of short messages are selected at the step S202, the controller 15 determines whether a multi-message unifying menu key is inputted or not at step S203. The multi-message unifying menu key is a predetermined menu key for receiving a command from a user to perform the multi-message unifying function. The controller 15 performs the multi-message unifying function on the selected short messages when the user selects the multi-message unifying menu key.

If the multi-message unifying menu key is not inputted at step S203, typical operations of handling short messages are performed at step S208 such as transmitting the short message or deleting the short message.

If the multi-message unifying menu key is inputted at step S203, the controller 14 determines whether a total size of the selected short messages is larger than a maximum message size at step S204. The maximum message size is a total size of short messages allowable to be included in single multimedia message.

For example, since a size of a short message is 90 bytes and a size of single multimedia message is about 2 kilo-bytes to 20 Kilo-bytes, single multimedia message can includes minimum 20 short messages. Therefore, the maximum message size may be about 20 times of a size of a short message.

If the total size of selected short messages is larger than the maximum message size at step S204, a predetermined message such as “exceed of the maximum message size” is outputted to the user through the multi-message unifying message interface at step S209. After outputting the predetermined message, the step S201 is performed again for selecting one or more short messages. Inhere, one or more of selected short messages may be cancelled to be selected according to another embodiment of the present invention for reducing the total size of the selected short messages.

If the total size of the selected short messages is smaller than the maximum message size at step S204, the controller 15 generates single multimedia message by unifying the selected short message into single multimedia message at step S205. That is, if the selected short messages can be included in single multimedia message, the selected short messages are unified as the single multimedia message.

In more detail, the controller 15 drives the multi-message unifying program (message unifying parser) in order to perform the multi-message unifying function. Then, various information are extracted from the selected short messages by analyzing the selected short messages such as information about contents, originators' telephone numbers, receivers' telephone numbers, or time of receiving. After extracting the information, the information are modified as a predetermined format, and stored in single multimedia message with the selected short messages. The predetermined format is a format to display each of short messages separately although the selected short messages are unified into the single multimedia message. Especially, the extracted information from the short messages is sorted according to each of short messages within the predetermined format, and the sorted information of the selected short messages is stored in the single multimedia message with the selected short messages. A time of receiving a short message or an originator's telephone number may be used as a reference of sorting. Also, the reference of sorting may be selected by a user through the multi-message unifying interface.

Meanwhile, as another embodiment of the present invention, a method for transmitting the generated multimedia message to a back-up server or other wireless communication terminal will be explained hereinafter.

As described above, single multimedia message is generated by unifying a plurality of selected short messages into the single multimedia message at steps S201 to 205.

After generating the multimedia message, receiver-side information is inputted from the user through the multi-message unifying interface at step S206. Herein, the receiver-side information may include a telephone number or an e-mail address directly inputted from the user, or a telephone number or an e-mail address selected from a list of telephone numbers or e-mail addresses stored in the memory of the wireless communication terminal.

The controller 15 transmits the generated multimedia message according to the inputted receiving-side information at step S207. That is, the generated multimedia message is transmitted to a back-up server or other wireless communication terminal. As described above, by unifying the short messages into single multimedia message and transmitting the single multimedia message as the plurality of the short messages, the plurality of short messages can be stored in an external system instead of storing the short messages in limited storage space in the wireless communication terminal. Also, a plurality of short messages can be conveniently transmitted by transmitting the unified single multimedia message instead of transmitting each of the short messages.

After transmitting the multimedia message, or before transmitting the multimedia message, the generated multimedia message may be displayed to the user through the multi-message unifying interface.

Meanwhile, as still another embodiment of the present invention, a method of updating the selected short messages to the generated multimedia message after performing the multi-message unifying function will be explained.

As described above, single multimedia message is generated by unifying a plurality of selected short messages at steps S201 to 205.

After generating the multimedia message, the controller 15 updates the selected short messages to the generated multimedia message. That is, the selected short messages are deleted from the memory 12, and the generated multimedia message is stored in the memory 12 as the selected short messages. Accordingly, the total number of stored messages is reduced. Therefore, more messages can be stored in the memory 12. Since a wireless communication terminal automatically deletes the messages stored in the memory 12 when the number of stored messages is exceeded over the maximum number of messages allowable to be stored rather than calculating total size of the stored messages. Therefore, if the total number of the stored messages is reduced, more messages can be stored in the memory 12.

Also, after or before updating the selected short messages to the generated multimedia message, the generated multimedia message may be displayed for a user through the multi-message unifying interface.

Meanwhile, in a method of unifying multiple messages in accordance with further still another embodiment of the present invention, a function for transmitting the generated multimedia message according to the steps S206 to S207 and a function for updating the short messages to the generated multimedia message are simultaneously performed after generating the multimedia message by unifying a plurality of short messages according to the steps s201 to S205.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, a plurality of short messages are unified to single multimedia message according to the present invention. Therefore, the messages stored in the wireless communication terminal can be managed effectively and conveniently.

Also, the plurality of short messages is unified to single multimedia message, and the single multimedia message is transmitted to a back-up server according to the present invention. Therefore, the short messages stored in the wireless communication terminal can be stored in an external system such as a back-up server or an e-mail server, and the messages are effectively and conveniently transferred to the external device.

Furthermore, the plurality of short messages is unified to single multimedia message, and the plurality of the short messages is updated as the single multimedia message according to the present invention. Since the plurality of short message is updated as the single multimedia message, a total number of stored messages may be reduced. Therefore, the messages stored in the wireless communication terminal can be managed effectively and conveniently, and also more messages can be stored in the memory of the wireless communication terminal.

The present application contains subject matter related to Korean patent application No. 2004-0055668, filed with the Korean patent office on Jul. 16, 2004, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A wireless communication terminal for unifying multiple messages, the wireless communication terminal comprising:
a wireless transceiver;
an output unit;
a memory for storing a multi-message unifying interface program, a multi-message unifying program, transmitting messages, receiving messages, and a unified message;
an input unit for receiving a selection signal for selecting one or more transmitting/receiving messages or a multi-message unifying menu key through a multi-message unifying interface; and
a controller for driving the multi-message unifying interface program and the multi-message unifying program, and generating single unified message by unifying the selected transmitting/receiving messages selected according to the selection signal.

2. The wireless communication terminal as recited in claim 1, wherein the memory stores receiving-side information including a telephone number and an e-mail address, the input unit receives the receiving-side information, and the controller transmits the generated unified message according to the received receiving-side information.

3. The wireless communication terminal as recited in claim 2, wherein the controller updates the selected transmitting/receiving messages stored in the memory to the generated unified message.

4. The wireless communication terminal as recited in claim 3, wherein the output unit outputs the generated unified message in response to the controller.

5. A method of unifying multiple messages in a wireless communication terminal, the method comprising:
receiving a selection signal for selecting a plurality of transmitting/receiving messages through a multi-message unifying interface, and selecting a plurality of the transmitting/receiving messages according to the selection signal; and
receiving a multi-message unifying menu key through the multi-message unifying interface, and generating single unified message by unifying the selected transmitting/receiving messages according to the multi-message unifying menu key.

6. The method as recited in claim 5, further comprising:
transmitting the single unified message according to receiving-side information inputted through the multi-message unifying interface.

7. The method as recited in claim 5, further comprising:
updating the selected transmitting/receiving messages to the single unified message.

8. The method as recited in claim 7, further comprising:
outputting the single unified message through the multi-message unifying interface.
